(19) United States
(12) Patent Application Publication
(10) Pub. No.: US 2004/0082330 A1
(43) Pub. Date: Apr. 29, 2004

(54) Method for handoff and redundancy using mobile IP

(76) Inventor: James Scott Marin, Murphy, TX (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/282,467

(22) Filed: Oct. 29, 2002

(51) Int. Cl. H04Q 7/20

(52) U.S. Cl. 455/438; 370/331

(57) ABSTRACT

A method for handing off a mobile call via a packet data network uses mobile internet protocol (IP). When a mobile station (12) enters a new area, it registers with a target base station (35). When a source base station (23) determines a handoff is required, a handoff request message (101/102) is transmitted to the home agent (21) of the mobile station. The home agent then arranges for handoff between the source base station (23) and the target base station (35) via a packet data network (30).

### BACKGROUND OF THE INVENTION

The present invention pertains to telecommunication systems and more particularly to a method for performing handoff between a base station and a mobile station in a wireless network.

In today's telecommunication systems and specifically within cellular networks, handoff of a mobile station provides the mobility for that mobile station. The user of the mobile station may wander from one cell to another cell or one base station to another base station and be totally oblivious to the handoffs which take place to enable his mobility while maintaining communications. In modern cellular networks, handoff has many types and implementations. For example, there is a hard handoff between mobile switching centers (MSC). In hard handoff, a connection is removed before a new connection is established (i.e. break before make). Further, there is a soft handoff which is performed between base stations (BS). In soft handoff, a new connection is made before a previous connection is broken (i.e. make before break). There are many types of handoff such a dormant mode, fast, and inter generation. Each type of handoff is typically implemented using special interfaces and special message exchanges between the switching nodes in the network.

These messages for supporting a handoff form a complex set of messages. Further, these messages are typically customized for the particular cellular network architecture upon which they are used. Since the sets of messages are complex for handoff and there is an array of different implementations, such handoff methods are excessively expensive to standardize; develop in a product and maintain throughout the product lifetime.

In 3GPP2 networks, for example, circuit switched voice and data networks are interconnected with packet data networks. These voice and data circuit networks such as a typical PSTN (Public Switch Telephone Network) typically used customized messages to perform handoff. These messages are based on conventional signaling system 7 protocols between the mobile switching centers and base stations.

Packet services provided by packet data networks typically use protocols developed by the Internet Engineering Task Force (IETF). These packet services are delivered to a mobile station via a base station, a packet control function and a packet data servicing node (PDSN). The PDSN functions are defined in Telecommunications Industry Association (TIA) standard IS-835. Typical circuit switched PDSN core networks are defined in TIA/EIA (Electronic Industries Association)-41 (ANSI-41). Base station interfaces are defined in TIA/EIA-2001.

Accordingly, it would be highly desirable to perform handoff and redundancy links with simplified message structures and easily standardizable message exchanges in modern wireless (e.g. second generation, 2G, third generation 3G, wireless local area networks, WLAN) networks.

### BRIEF DESCRIPTION OF THE DRAWING

FIG. 1 is a block diagram of a wireless network in accordance with the present invention.

FIG. 2 is a message flow diagram of a soft handoff method between base stations in accordance with the present invention.

FIG. 3 is a block diagram of a packet data network in accordance with the present invention.

FIG. 4 is a layout of data for a registration request message in accordance with the present invention.

FIG. 5 is a layout of data of a registration reply message in accordance with the present invention.

FIG. 6 is a message flow diagram of a method for handoff in accordance with the present invention.

### DESCRIPTION OF THE PREFERRED EMBODIMENT OF THE INVENTION

The present invention includes a method for performing handoff (HO) and redundancy links between a base station and a mobile station in a modern wireless network. In modern wireless systems that use code demand multiple access (CDMA) 2000, circuit services such as voice are provided by the PSTN and packet data services are provided by a packet data network.

The air interfaces defined in TIA/EIA-2000. Mobility is a key function of such cellular systems. As a mobile station moves physically, service is provided by base stations that are typically in fixed locations. In the CDMA 2000 architecture hard handoffs are handled between mobile switching centers and soft handoffs are handled between base stations. The main function of handoff is to maintain service as the mobile station is transferred from one base station to another.

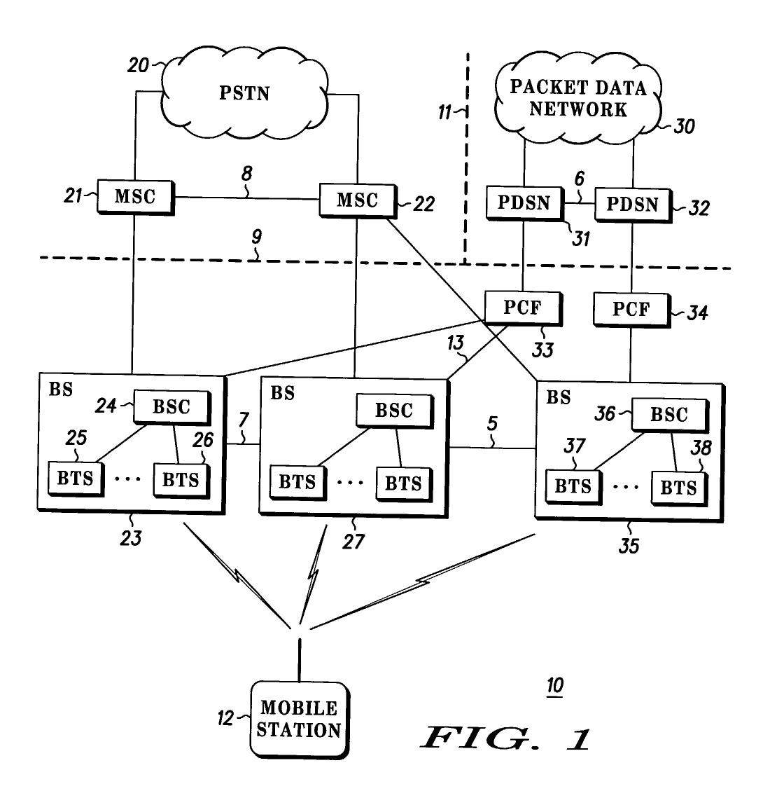

FIG. 1 depicts a modern network for a CDMA 2000 system that is standardized by the Third Generation Partnership Project 2 (3GPP2). The functional operations of such a system are defined in TIA/EIA-2001.3-B and related standards.

Referring to FIG. 1, a block diagram of a 3GPP2 network 10 is shown. The portion to the left of the dashed line 11 and above line 9 is the circuit switched voice and circuit switched data network, which includes PSTN 20. On the right side of dashed line 11 and above line 9 is the portion of network 10 which is termed the packet data network 30. The packet data network includes the packet data serving node (PDSN).

The PSTN portion 20 of network 10 includes one or more mobile switching centers 21 and 22, which are connected via trunk lines 8 for performing, among other functions, hard handoff. Mobile switching centers have many implementations including the use of soft switches. Mobile switching center 21 connects to one or more base stations 23 which includes base station controller (BSC) 24 and base transceiver stations (BTS) 25 and 26. Similarly, mobile switching center 22 connects to one or more base stations 27 which includes base station controller and base transceiver stations. Base stations are connected by interfaces 5 and 7 which are used for, among other functions, soft handoff.

Mobile station 12 may connect to base station 23, 27, or 35 when it requires voice or data communication. Alternately, if the PSTN 20 has a communication for a mobile station 12, MSCs 21, or 22 will locate the mobile station 12 and establish connection to the appropriate (generally the nearest) base station 23, 27 or 35.

Packet data network 30 connects to one or more packet data servicing nodes 31 and 32, which are connected by interface 6 for, among other functions, performing handoff of a packet call. Packet data servicing node 31 connects to one or more packet control function 33 which is coupled to one or more base stations 23, 27 and 35. PDSN 32 connects to one or more packet control function (PCF) 34 which is coupled to one or more base stations 35. Base station 35 includes base station controller 36 and base transceiver station 37 and 38. MSC 22 is coupled to base stations 27 and 35 in this example.

Given the network 10 of FIG. 1, a mobile originated circuit call is described in the standards at (TIA/EIA-2001.3B). Mobile station terminated circuit calls are also well known and will not be described herein. Further, the methodology of handoff is known in the art.

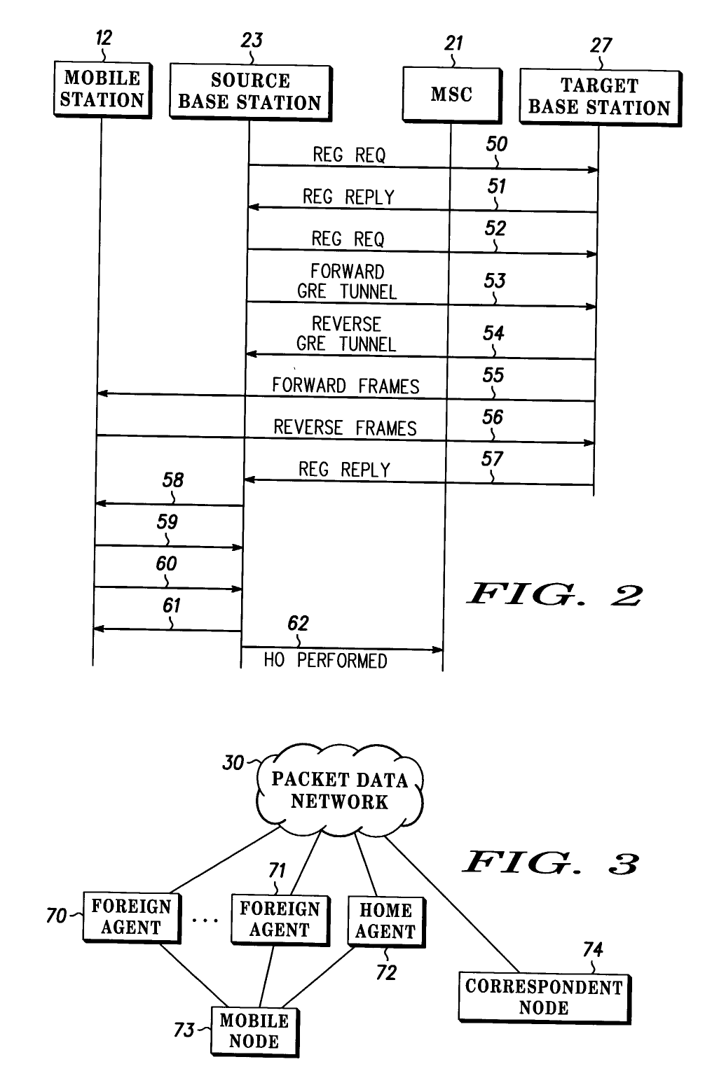

Referring to FIG. 2, a message flow diagram of a soft handoff between base stations is shown that extents the prior art by adapting mobile IP messages as defined in RFC3220 (and successor standards). This soft handoff methodology will be shown as a basis for explaining the mobile IP controlled handoff to be shown infra. In this model, the mobile station 12 acts as the mobile node as defined in the mobile IP protocol. The source base station 23 acts as a proxy for the mobile station 12. The target base station 27 acts as the foreign agent (FA) as described in the mobile IP protocol. Messages between the mobile station 12 and the base stations 23 and 27 remain as defined in TIA/EIA-2000, but messages between the base stations 23 and 27 are replaced with mobile IP messages. Base station specific parameters, if required for handoff, are communicated by the critical vendor specific extension (CVSE) and normal vendor specific extension (NVSE) mechanism supported by mobile IP.A source base station 23 determines that mobile station 12 will require a handoff to another base station soon. Base station 23 determines that target base station 27 is most likely to be able to provide mobile station 12 a viable link. Accordingly, source base station 23 sends a registration request message 50 instead of an A7 handoff request to target base station 27 (50). In response, target base station 27 sends a registration reply message 51 to source base station 23. The registration reply message 51 is sent instead of an A3 connect message, for example.

In response, source base station 23 sends a registration request message 52 which replaces the A3 acknowledge (ACK) message to target base station 27.

Next, source base station 23 sends a generic route encapsulated message (tunnel) 53 containing A3 CE data forward message to target base station 27. A tunnel is created between the source base station 23 and the target base station 27. The target base station 27 responds with a reverse generic route encapsulated tunnel 54 containing A3 CE data reverse message which initially contains idle frames. Since the target base station 27 now has a link to mobile station 12 it forwards the data frames to mobile station 12 55. The mobile station 12 sends reverse frames 56 to the target base station 27.

Next, target base station 27 sends an registration replay message instead of a A7 handoff request acknowledge message 57 to the source base station 23.

Next using TIA/EIA-2000 messages, source base station 23 sends a handoff direction message 58 to mobile station 12. Mobile station 12 responds to handoff direction message 58 with a mobile station acknowledge order message 59 which is transmitted to the source base station 23. Mobile station 12 then completes the handoff and as a result transmits a handoff completion message 60 to source base station 23. Source base station 23 responds with a base station ACK order message 61. Lastly, source base station 23 informs the mobile switching center 21 that a handoff of mobile station 12 has been performed by handoff performed message 62. As has been shown a soft handoff has been performed directly between two base stations, a source base station 23 and a target base station 27.

FIG. 3 is a block diagram depicting the packet data network 30 of network 10 shown in FIG. 1. FIG. 3 shows the entities in a mobile IP network. These entities are mapped onto the cellular network as follows. A typical packet data subscriber such as mobile station 12 is termed a mobile node (MN) 73. Mobile node 73 is coupled via the subscriber's home network (not shown) to a home agent (HA) 72 which in turn is coupled to the packet data network 30. A number of foreign agents (FA) 70-71 are also coupled to the packet data network 30. These foreign agents interface with mobile users when a user is in an area outside his home network. That is, when a user is outside his home network he is in a foreign or visited network.

The mobile IP (Internet Protocol) enables a mobile node to move to various points in an IP based network. The mobile node may change its physical link from one point to another without having to change its corresponding IP address. That is as mobile node 73 moves about, correspondent node (CN) 74 will be able to use the same IP address (i.e. the home address) to communicate with mobile node 73 regardless of which network mobile node 73 is connected to and serviced by. To accomplish this the mobile IP protocol will be used. This protocol is defined in IETF RFC3220. Mobile IP version 4 is shown in this example but the same concept applies for mobile IP version 6.

Mobile node 73 registers with this home agent 72. Referring to FIG. 1, mobile node 73 corresponds to mobile station 12 and the home agent 72 corresponds to the PDSN 32 or MSC 21 in this examples. The mobile node 72 connects through its base station 27 and establishing link 13 with packet control function 33. Referring again to FIG. 3, as mobile node 73 moves physically a mobile node 73 may connect to a foreign agent 70 which is also connected to packet data network 30.

When correspondent node 74 which knows mobile node's 73 home IP address, sends a data packet to mobile node 73 through packet data network 30, network 30 routes the packet to the home agent 72 of mobile node 73. Home agent 72 determines whether mobile node 73 is on its home network or a foreign or visited network. If mobile node 73 is located on the home network, the home agent simply routes the data packet to mobile node 73. If the mobile node 73 is located on a foreign network, the home agent 72 encapsulates the data packet in an IP tunnel. The encapsulated data packet is then routed through network 30 to foreign agent 70, for example. As part of the IP tunnel, home agent 72 also includes the identity of the foreign agent 70 which is associated with mobile node 73's visited or foreign network.

Either the foreign agent 70 or the mobile node 73 may de-encapsulate the data packet. The de-encapsulation depends on which form of encapsulation was used by the home agent. That is, minimal encapsulation which is specified by RFC 2004 or generic route encapsulation which is specified by RFC 1701 may be selected.

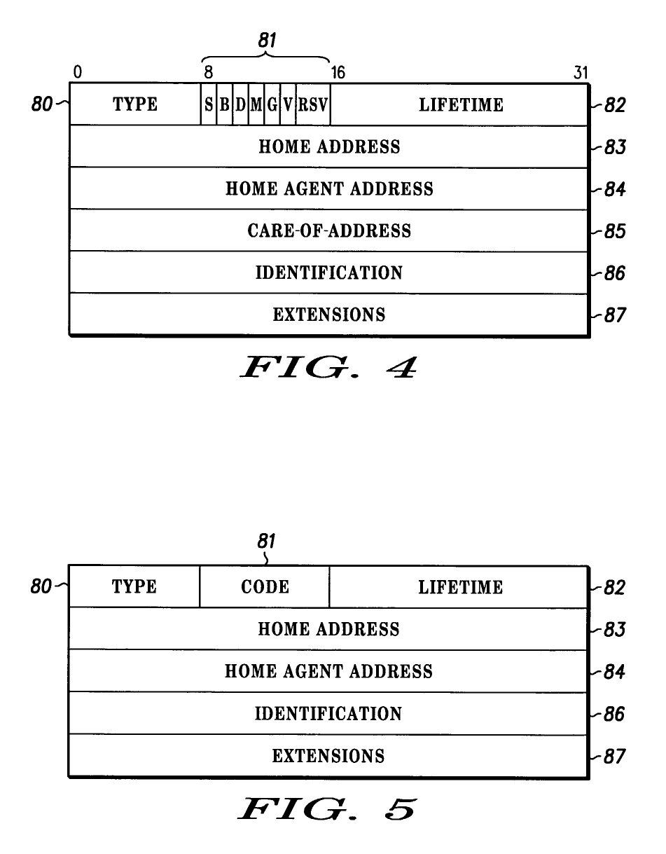

Mobile IPV4 has two message registration types. These two types are the registration request shown in FIG. 4 and the registration reply shown in FIG. 5. The first word of the registration request shown in FIG. 4 includes a type field 80, a code field comprising individual indicators 81 and a lifetime field 82. Next, a mobile node home address 83 is included. The identity of the mobile node's home agent is next 84. A care of address 85 is used for sub-network routing. Lastly, an identification field 86 and any extensions 87 are included in the message.

Referring to FIG. 5, the registration reply message is shown. The various fields of the reply message are exactly the same as the request message except that there is no care of address 85 in the reply message.

Referring again to FIG. 3, mobile node 73 may be discovered on or can register on a sub-network using IPV4 message protocol in RFC1256. When mobile node 73 is on a visited network, it sends the registration request message of FIG. 4 to the home agent 72. This registration request message includes a current care of address (COA). As a result, home agent 72 knows how to route messages for mobile node 73 through foreign agents to affect their delivery to mobile node 73.

If the COA is associated directly with mobile node 73, the COA is called a co-located COA. Otherwise the COA is associated with foreign agent 70 for example. The registration request message of FIG. 4 included the functions of connection establishment, connection maintenance and connection release. Current standard messaging for mobile initiated circuit calls are governed by TIA/EIA standards messages specified in TIA/EIA-2001.3-B. Mobile terminated calls are also specified in standards TIA/EIA-2001.3-B.

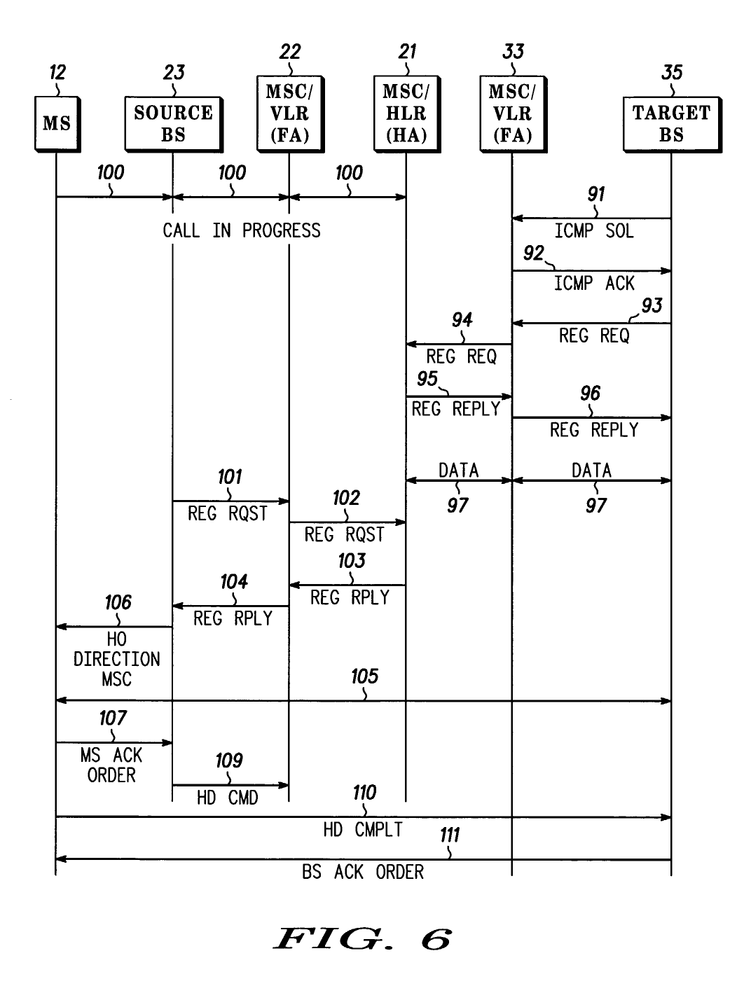

Referring to FIG. 6, a message flow for handoff via a mobile switching center using mobile internet protocol is shown. First, it is assumed that there is a mobile call in progress 100 between mobile station 12, source base station 23 mobile switching center 22, which is acting as a foreign agent, in association with MSC 21 which has mobile station 12's home location register (HLR) and is acting as mobile station 12's home agent. For purposes of explanation it is next assumed that mobile station 12 moves into a coverage area that is controlled by target base station 35. Foreign agents such as MSC 33 continuously send router advertisement messages in order to discover new mobile nodes that enter their coverage area, such as mobile station 12 for example. Mobile station 12 is deemed to have obtained an local IP address with the target base station 35 using internet control message protocol (ICMP) solicitation message 91 and ICMP acknowledge message 92. The target base 35 on behalf of mobile station 12 sends a registration request message 93 to MSC 33 which is acting as a foreign agent. MSC 33 relays the registration request 94 to MSC 21 which is acting as the home agent. MSC 21 sends a registration reply 95 to MSC 33 which relays the registration reply 96 to the target BS 35. MSC 21 can then route call data 97 to the MS 12 via target BS 35 in addition to the call in progress 100. With this mechanism, two or more links can be established to the MS 12 such that the MS 12 may select one or more link. The existence of multiple links permits one or more link to fail without interrupting service to MS 12. The existence of multiple links also permits the MS 12 to switch between the links without incurring the delay typically associated with hard handoff. The packet delay probability on each link is controlled using the differential services (Diffserv) protocol as described in RFC2574.

Source base station 23 determines that the signal for mobile station 12 is weak and that a complete handoff of mobile station 12's link is necessary. Source base station 23 sends a registration request message 101 to the foreign agent or MSC 22. As shown in FIG. 4, source base station 23 sets the lifetime field 82 equal to zero. This indicates that the source base station 23 is requested to de-register from supporting mobile station 12's communication link.

Next, foreign agent 22 sends the registration request 102 which is formerly a handoff request message to the home agent, MSC 21. Home agent 21 then returns a registration reply message 103 to foreign agent 22. And foreign agent 22 returns the registration reply message 104 to the source base station 23.

Then, base station 23 using TIA/EIA-2000 messages, sends a handoff direction message 106 to mobile station 12. As a result mobile station 12 switches to receive the traffic stream of data from the target base station 35 (105).

Responsive to the handoff direction message 106, mobile station 12 sends an ACK order message 107 to source base station 23. As a result source base station 23 discontinues its data stream to mobile station 12. Source base station 23 then sends a handoff command 109 to MSC 22 which is acting as the foreign agent. Next mobile station 12 sends a handoff complete message 110 to its new base station, target base station 35. Lastly, base station 35 responds with a base station ACK order 111 to acknowledge that the handoff has been completed.

Excessive and unpredictable delay in when IP based networks is mitigated by using the make-before-break flow implied in FIG. 6 and by using the Diffserv protocol. Diffserv used the type-of-service field in the IP protocol header as an enhanced method for shaping traffic on IP networks. Handoff messages and traffic frames are routed using the Diffserv mechanism at the priority necessary to meet delay requirements.

As is shown from the above methodology, the present invention extends the use of mobile internet protocol in modern 3GPP2 networks to include handing off legacy type links using mobile IP. The present invention methodology helps to standardize handoff interfaces whether they be hard or soft handoff. In addition the standard methodology encourages the base stations to aggressively establish multiple links with the mobile station.

Although the preferred embodiment of the invention has been illustrated, and that form described in detail, it will be readily apparent to those skilled in the art that various modifications may be made therein without departing from the spirit of the present invention or from the scope of the appended claims.

1. A method for handoff using mobile internet protocol (IP) comprising the steps of:
providing a call between a mobile station (MS) and a mobile switching center (MSC) via a source base station;
requesting by the source base station a handoff for the mobile station using mobile IP, said requesting being to a home agent of the mobile station; and
coupling by a foreign agent a target base station to the mobile station using mobile IP.

2. A method for handoff as claimed in claim 1, wherein there is further included a step of sending a handoff direction message from the source base station to the mobile station, said handoff direction message including an identity of a target base station.

3. The method for handoff as claimed in claim 2, wherein there is further included a step of receiving by the mobile station data from the target base station.

4. The method for handoff as claimed in claim 2, wherein there is further included a step of acknowledging by the mobile station the handoff direction message to the source base station.

5. The method for handoff as claimed in claim 2, wherein there is further included a step of discontinuing data transmission between the source base station and the mobile station.

6. The method for handoff as claimed in claim 5, wherein there is further included a step of, responsive to the step of discontinuing, sending a handoff completed message from the source base station to a foreign agent.

7. The method for handoff as claimed in claim 5, wherein there is further included a step of sending a handoff completion message by the mobile station to the target base station indicating the handoff has been completed.

8. The method for handoff as claimed in claim 7, wherein there is further included a step of acknowledging by the target base station the handoff completion message of the mobile station.

9. The method for handoff as claimed in claim 1, wherein the step of requesting by the source base station includes a step of setting a lifetime field of a handoff direction message to a particular value, said particular value indicating that the source base station is seeking to handoff a link of the mobile station.

10. The method for handoff as claimed in claim 1, wherein the step of requesting by the source base station further includes a step of setting a care of address field in a registration request message, said care of address field for routing a requested handoff through a packet data network using mobile IP.

11. The method for handoff as claimed in claim 1, wherein there is further included a step of coupling the target base station to the mobile station prior to disconnection the source base station from the mobile station.

12. The method for handoff as claimed in claim 1, wherein there is further included a step of providing multiple links from the source base station and the target base station to the mobile station.

13. The method for handoff as claimed in claim 12, wherein the multiple links are maintained using differential services protocol (Diffserv).

14. A method for handoff via a packet data network comprising the steps of:
providing a call between a mobile station (MS) and a mobile switching center (MSC) via a source base station;
registering by the mobile station with a target base station, said target base station being served by a packet data network; and
requesting by the source base station a handoff of a link of the mobile station to the target base station, said requesting being made through the packet data network.

15. The method for handoff as claimed in claim 14, wherein there is further included a step of sending a solicitation message by the target base station through the packet data network to a foreign agent.

16. The method for handoff as claimed in claim 15, wherein there is further included steps of:
receiving by the target base station an acknowledge message in response to the solicitation message; and
sending a registration request message by the target base station to the foreign agent.

17. The method for handoff as claimed in claim 16, wherein there is further included a step of sending the registration request message by the foreign agent to a home agent associated with the mobile station.

18. The method for handoff as claimed in claim 17, wherein there is further included a step of acknowledging the registration request message by the home agent to the target base station.

19. The method for handoff as claimed in claim 14, wherein there is further included a steps of:
sending a handoff request by a source base station via a second foreign agent to the home agent of the mobile station; and
sending by the source base station a handoff direction message to the mobile station.

20. The method for handoff as claimed in claim 19, wherein there is further included a step of sending a handoff direction message from the source base station to the mobile station.

21. The method for handoff as claimed in claim 20, wherein there is further included a step of coupling the target base station to the mobile station via the packet data network.

22. The method for handoff as claimed in claim 21, wherein there is further included the step of transmitting data from the target base station to the mobile station via the packet data network.

23. The method for handoff as claimed in claim 22, wherein there is further included a step of discontinuing a transmission of data between the source base station and the mobile station in response to the step of sending the handoff direction message.

24. The method for handoff as claimed in claim 14, wherein there is further included a step of coupling the target base station to the mobile station prior to disconnection the source base station from the mobile station.

25. The method for handoff as claimed in claim 14, wherein there is further included a step of providing multiple links from the source base station and the target base station to the mobile station.

26. The method for handoff as claimed in claim 25, wherein the multiple links are maintained using differential services protocol (Diffserv).
